(19) United States
(12) Patent Application Publication
(10) Pub. No.: US 2008/0077474 A1
(43) Pub. Date: Mar. 27, 2008

(54) Method and system for global consolidated risk, threat and opportunity assessment

(76) Inventors: Mark E. Dumas, Vienna, VA (US); James A. Stokes, Richmond, VA (US); Jason R. Dalton, Vienna, VA (US); Ashok Sankar, Leesburg, VA (US)

Correspondence Address: WILLIAMS MULLEN, 222 CENTRAL PARK AVENUE, SUITE 1700, VIRGINIA BEACH, VA, 23462, US

(21) Appl. No.: 11/903,032

(22) Filed: Sep. 20, 2007

Related U.S. Application Data
(60) Provisional application No. 60/846,039, filed on Sep. 20, 2006.

(51) Int. Cl. G06Q 10/00; G06F 17/40; G06F 19/00

(52) U.S. Cl. 705/10

(57) ABSTRACT

A system, method and framework incorporates one or more analytical engines and sensitivity models to process data and project real-time or near-real-time threats, risks, vulnerabilities and/or opportunities statically or continuously. Response assessments can be reflected on a graphical interface so as to provide a consolidated depiction of threats, risks, vulnerabilities and/or opportunities. Response assessments can also be reflected as one or more signal controls to a physical device.

### REFERENCE TO RELATED APPLICATIONS

This application claims the benefit of U.S. provisional patent application Ser. No. 60/846,039, filed Sep. 20, 2006 and entitled “Method and System for Global Consolidated Risk and Threat Assessment”, the disclosure of which is incorporated herein by reference.

### FIELD OF THE INVENTION

The present invention relates to spatial modeling, and more particularly provides a system, method and framework incorporating analytical engines to process data and project real-time or near-real-time threats, risks, vulnerabilities and/or opportunities continuously, including consolidating the threats, risks, vulnerabilities and/or opportunities into a graphical user interface and modeling client assets and resources in conjunction therewith.

### Background Discussion

Geospatial modeling offers an approach to solutions to a variety of corporate, governmental and individual problems. Understanding where a particular threat, risk or opportunity may be present or may occur in the future is critical to effective and successful decision making. Unfortunately, many decisions are made with incomplete, outdated or misleading information, resulting in correspondingly sub-par outcomes.

For example, if a corporation desires to open a new office in a selected geographical area, many factors influence the specific location. Proximity to employees, transportation infrastructure, communications infrastructure, political unrest, societal issues, natural hazards, profit potential, market and other factors can come into play. If there is a market for umbrellas in a particular region having heavy annual rainfall, for example, but the region is susceptible to random terror attacks, then an umbrella retailer company may decide that the risks outweigh the benefits of locating in that region. Without a current, accurate picture of potential risks, vulnerabilities, threats and/or opportunities, the retailer can easily make the wrong or sub-optimal decision. Further, if the retailer cannot adjust variables such as its own risk tolerance, for example, then it may not be adequately assessing all of its location options. For example, if the retailer has a low risk tolerance and cannot find any reasonable locations for its new store, then it would be helpful to know which potential store locations may be deemed suitable if the retailer raises its risk tolerance. Such determinations suffer when they are made subjectively under currently known means.

As another example, if an insurance company is considering issuing a catastrophic loss policy to a company in a region susceptible to earthquakes, tsunamis or other natural disasters, it would benefit from a risk evaluation that considers various conditions that may change over time. For instance, if tectonic plate shifting or global weather patterns indicate that the risk of an earthquake of a threshold-exceeding magnitude is not likely to occur over the life of the insurance policy, then the insurance company may be more willing to issue the policy or may adjust its premium accordingly.

Past systems for attempting to assist businesses, governments and individuals with such assessments are typically paper-based, and are typically provided based upon old and untrustworthy data. Further, past systems do not combine multiple sensitivity models in a meaningful way. For example, while it might be possible for a consultant to analyze weather data on one hand, and terrorist activity on another, it is difficult for the consultant to aggregate the two in a way that informs a decision maker as to an aggregated risk, threat or opportunity assessment for a particular undertaking of interest.

### SUMMARY OF THE PRESENT INVENTION

One aspect of the present invention involves referencing one or more databases of rapidly collected and organized, frequently changing geospatial and aspatial information on a cellular level (i.e., discrete, small surface areas) in order to ensure that a consolidated risk, threat and/or opportunity assessment and resulting presentation are as accurate and current as possible. In one embodiment, the present invention can incorporate systems that coordinate data collection resources, both in the field and remotely, such as those described, for example, in U.S. Patent Application Publication No. 2005/0255842 (the '842 publication) to Dumas et al., entitled “Communication System And Method For Comprehensive Collection, Aggregation And Dissemination Of Geospatial Information.” This publication is hereby incorporated by reference in its entirety.

The present invention can further incorporate and/or work alongside systems capable of forecasting events, threats and/or results based on geospatial modeling, such as, for example, that described in U.S. Patent Application Publication No. 2005/0222829 (the '829 publication) to Dumas entitled “Method And System For Forecasting Events And Results Based On Geospatial Modeling,” which is hereby incorporated by reference in its entirety. Such systems consider geographical features and multiple types of measurements connecting past incidents to those features as part of an overall system and method for rapidly and accurately assessing likelihoods of future events or results, and can provide the capability to alert remote users within a geographical area of interest and in communication with the system, in the event that an assessment reveals a forecast for activity near a user's location. The present invention can operate not only on a one-off type assessment basis, but also can be employed as an ongoing situational awareness engine with real-time or substantially real-time monitoring and alerting. This allows the present invention to continually assess a situation, collect appropriate data, process the information, analyze the information, deliver assessments in an appropriately tailored fashion and manage the situational awareness on a continually updated basis.

The present invention, in one embodiment, provides a decision support system for assisting in a variety of decisions based on the subject matter and specific sensitivity model(s) involved. For example, given a global cell-based grid, the present invention can assist in providing an owner or key individual of a global company with a real-time or near-real-time view of one or more of various types of threats, the likelihood of the threats and the potential consequences of the threats in order to enable the individual to implement appropriate response measures to mitigate the potential damage associated with the threat. In one embodiment, the present invention provides for automated implementation of response measures. The present invention can further provide instruction to, and control of, client resources and assets, whether those resources and assets are fixed (e.g., furniture, doors, computer systems, access control elements), mobile (e.g., vehicles, portable communications devices), human (e.g., employees, contractors, customers), or infrastructure-related (e.g., buildings, pipelines, fiber, cables, dams, electrical grid). As an example, if a global consulting company with offices housing tens of thousands of people worldwide should discover through the present invention that the potential for earthquake, fire, or terrorist strike, for example, is elevated beyond a pre-determined threshold, the company can provide an alert to those who may be affected or can otherwise facilitate preparations for withstanding, evacuating, or responding to the threat. The present invention can further be used to forecast, based on predetermined risk tolerance levels, where to allocate future sites, for example.

There is no limit to the subject matter which can be modeled and effectively represented to the interested individual or entity. For example, in one embodiment of the present invention, a consolidated risk assessment can be derived for any latitude/longitude pair according to one or more sensitivity models selected for inclusion, such as one or more of: physical threat or safety models, health models, terrorism models, sociological models, crime models, weather or natural hazard models, political models, geo-political models, and/or economic models. Instead of a latitude/longitude selection, one could provide city, state, zip, country, or street address and risk assessment can be provided as a “roll-up” of data aggregation. In another embodiment, one could provide odd geometry (e.g., box, line, circle, ellipse) and get a weighted consolidation at a certain accuracy specification. One could also obtain a consolidated risk or opportunity assessment based on a given route (e.g., airline point-to-point travel path).

A user's access to the site can be governed by customizable rules, including rules that govern which data, models, and/or model combinations a user has access to. In one embodiment, the resolution of the modeling can be limited based on user rights. For example, a certain user might only be able to execute a model that provides a consolidated risk for 1 km² cell sizes versus another user who might be able to execute the same model at 100 m² cell sizes. The difference could arise from economic factors that allow a user the higher fidelity, or perhaps security reasons (for example, it is known that the U.S. military degrades the permission of the GPS coordinates received for the general public, but allows military receivers precision access). Additionally, a user's personal modeling, data, and consolidation preferences could vary in a user-defined fashion within the limits of accessibility governed by security or economic constraints to the overall system.

By enhancing real-time or near real-time situational awareness of diverse, global factors, the present invention can provide proactive protective measures for critical resources, including critical infrastructure, operating assets (fixed or mobile) and human resources. The present invention considers the context of the customer's objectives to essentially customize the assessment report and response. By offering predictive assessments of future risks, threats, opportunities and vulnerabilities in geospatial areas of interest, the present invention can provide substantial decision support for allocation of defensive and offensive resources. Further, the present invention provides a central facility by which an entity can plan, coordinate and respond to emergencies, incidents, threats, risks, vulnerabilities and opportunities.

### BRIEF DESCRIPTION OF THE DRAWINGS

FIG. 1 is a schematic view of different components associated with one embodiment of the present invention.

FIG. 2 is a schematic view of different components associated with another embodiment of the present invention, including the components shown in FIG. 1.

FIG. 3A is a diagram illustrating sample model information layers for use in connection with the present invention.

FIG. 3B is a sample matrix view illustrating one embodiment of a visual display for use in connection with the present invention.

FIG. 4 illustrates an example of how the sample matrix view in FIG. 3B can be expanded or presented on a per-block basis.

FIG. 5 illustrates multiple sample visual displays which can be associated with the present invention, including calculating and aggregating at different cell sizes.

FIG. 6 is a diagram showing how the sample visual displays of FIG. 5 can be exploited to obtain additional visual displays and associated information.

FIG. 7 is a diagram illustrating a geo-fence aspect in connection with the present invention.

FIG. 8 is a diagram illustrating the aggregate risk monitoring capability of the present invention.

FIG. 9 is a diagram illustrating operator thresholds applied to automated alerting of aggregate or case specific risk scores in the present invention.

FIG. 10 is a diagram illustrating threshold triggers that can propagate higher order effects in the system described by the present invention.

FIG. 11 is a schematic diagram of a conceptual architecture of one embodiment of the end-to-end delivery process of the system of the present invention.

### DETAILED DESCRIPTION OF THE PREFERRED EMBODIMENTS

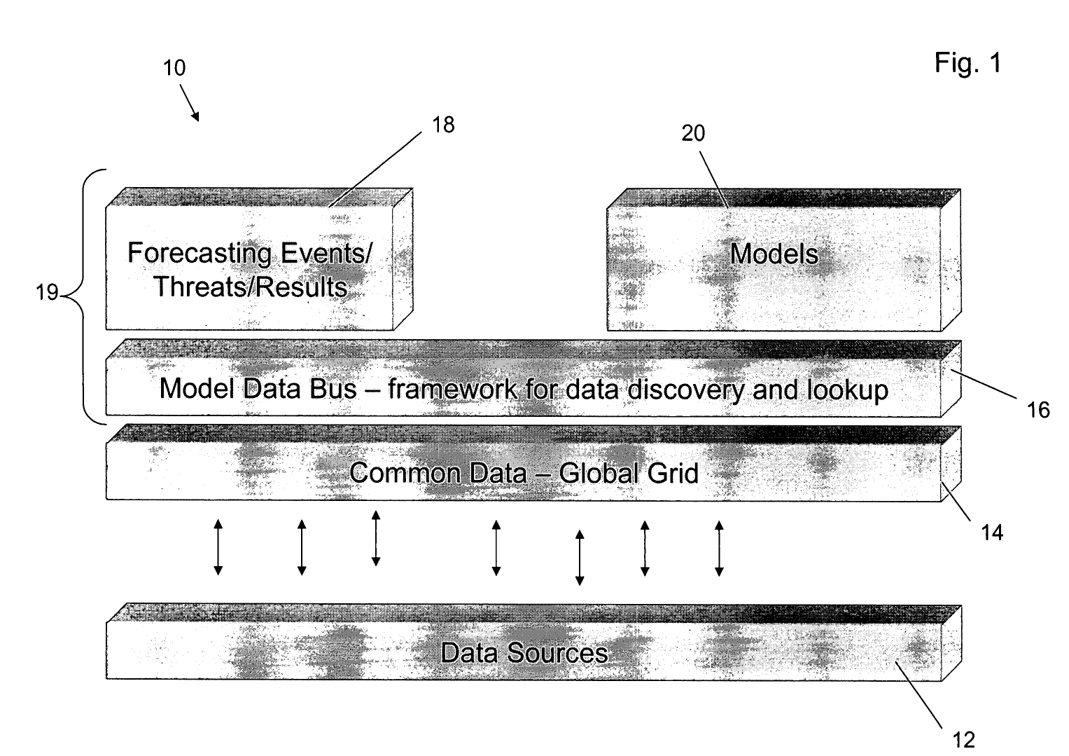

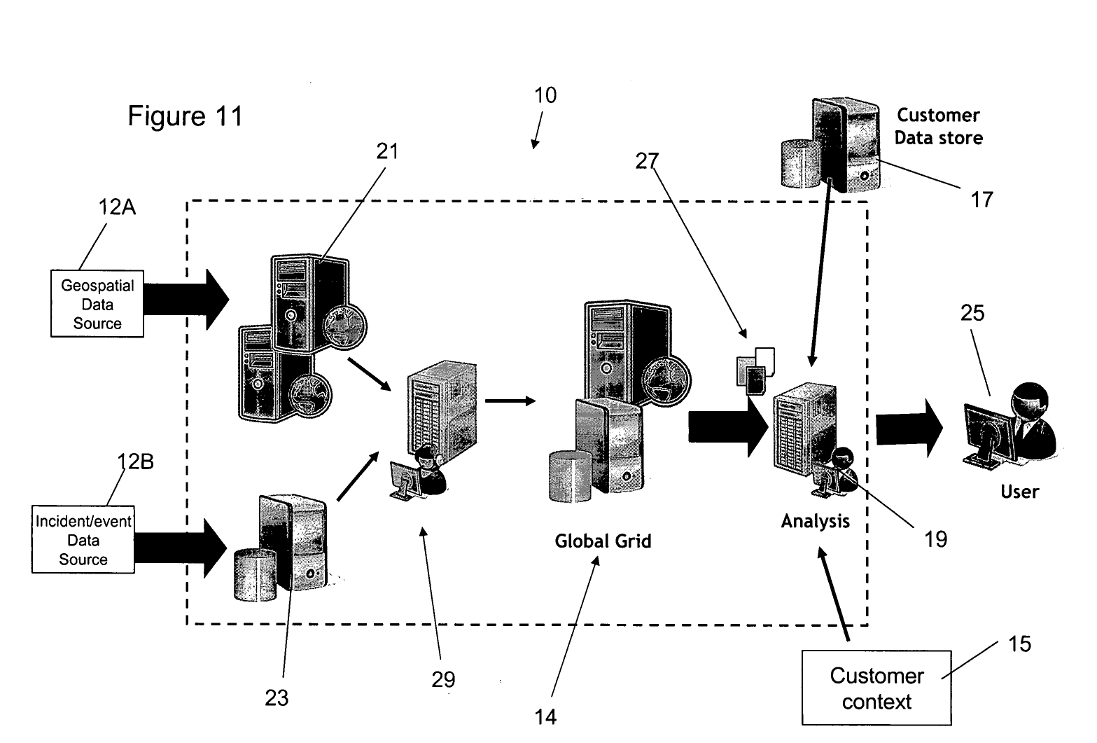

As shown in FIG. 1, the present invention comprises, in one embodiment, a system 10 having one or more data sources 12 such as those identified in the '842 publication. The data sources 12 ensure that the system 10 is operating with the most complete, accurate, current and verified information available to the extent possible. As shown in the embodiment in FIG. 11, the data sources can include geospatial data sources 12A and incident/event data sources 12B. The system 10 further includes common data 14 such as geographic and/or geospatial data that can be organized into the form of a global grid, such as described or inferred by the above cited publications. The data sources 12 typically continually provide updated data in the context of (or automatically arranged according to) the common data grid, although it is possible for one or more of the data sources 12 to be static and/or only periodically updated. Appropriate mechanisms, methods and systems for forecasting events, threats and/or results can be provided as at 18 for interacting with the data sources 12, 14 via a model data bus 16. The elements 18 can comprise or include elements as described in the '829 publication referenced above, for example. In one embodiment of the present invention, the elements 18 include a forecasting component which assesses the likelihood of future events of a specific event type pertaining to the requested assessment, with the forecasting component including a signature derivation component for deriving a geospatial signature pattern for past stored events of the assessed event type within the requested location. This forecasting component can act to continually update the signature based on customer context information at predetermined intervals and as updated data becomes available.

Appropriate models 20 can also be provided for interacting with the data sources 12, 14 through model data bus 16. The bus 16 provides a framework for data discovery and lookup by elements 18 and models 20. In one embodiment of the present invention, forecasting elements 18, model elements 20 and bus 16 comprise an analytical engine 19 as more fully described in connection with FIG. 11. Models 20 can be any of a number of different, relevant, inter-related or (perceived) unrelated models including, for example, weather models, terrorist threat models, health models, health risk models, infrastructure models, financial risk models, geographic models, geospatial models, human interaction models (e.g., new construction, teardowns, transportation initiation or termination, etc.), natural interaction models (e.g., volcanoes, sinkholes, etc.), traffic models, transportation routing models, allocation models, and so forth. In one embodiment, models may be undefined or lack proper minimum data to run, or lack proper time-relevant data to run. In another embodiment, models can run with stale data but outputs can be counted “less”, i.e., with less model confidence. In another embodiment, models can be color coded in a dashboard for their relevance. Models can be selected based upon the user's or customer's specific context defined as described elsewhere herein, or the system of the present invention can automatically select appropriate models to use to execute the requested assessment. For example, if a user wishes to have its computer systems backed up and turned off if a building access control protocol is violated or if a major weather event is sensed, then the present invention may automatically select a weather model and an infrastructure (e.g., building security) model.

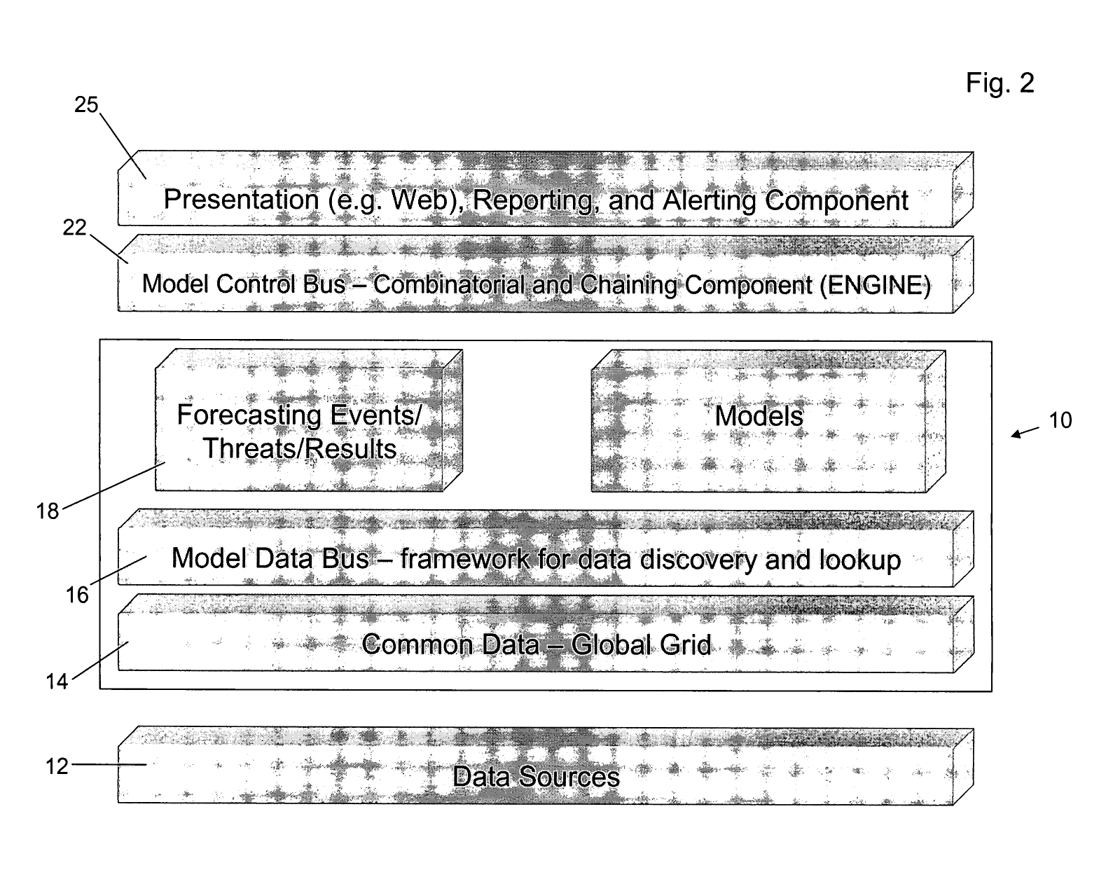

Enjoined together or by at least combining several of the system 10 components, the present invention provides a powerful tool for use by an appropriate engine in order to facilitate processing for presentation, reporting, alerting or other visual display, interaction or communication method as may be required or appropriate. As shown in FIG. 2, the present invention can incorporate a model control bus 22, such as a combinatorial and/or chaining component for appropriate processing of the information stored and manipulated by system 10. In one embodiment, the model control bus 22 is a powerful analytical engine that can exercise one or more models and one or more forecasting processes against the information collected and stored in a database pursuant to the various data sources 12 and common data 14 in order to provide a consolidated body of knowledge capable of being accessed, produced, exploited, displayed and communicated via interaction and presentation layer 25.

Interaction/presentation layer 25 is the end user's gateway to the engine and gaining meaningful understanding of whatever specific assessment the end user desires. This layer includes an interface component that can receive instructions from the user to provide a user-requested risk, threat or opportunity assessment pertaining to a location. The location can be specific (e.g., Tel Aviv, Israel) or general (e.g., global major cities) and can include multiple locations. Further, the risk, threat or opportunity can invoke one model or a plurality of models. Models can further be classified into categories such that, for example, earthquakes, floods and tidal waves can be categorized as “natural hazards,” violent crime and bombing can be categorized as “societal hazards,” pandemics, chemical spills, radiation and pollution can be categorized as “health hazards,” and natural hazards, societal hazards and health hazards can be categorized as “hazards.” Opportunity models can entail potential customer's segmentations, real estate return on investment models, seismic models that help indicate the likelihood of natural resource discovery such as hydrocarbons or diamonds, for example.

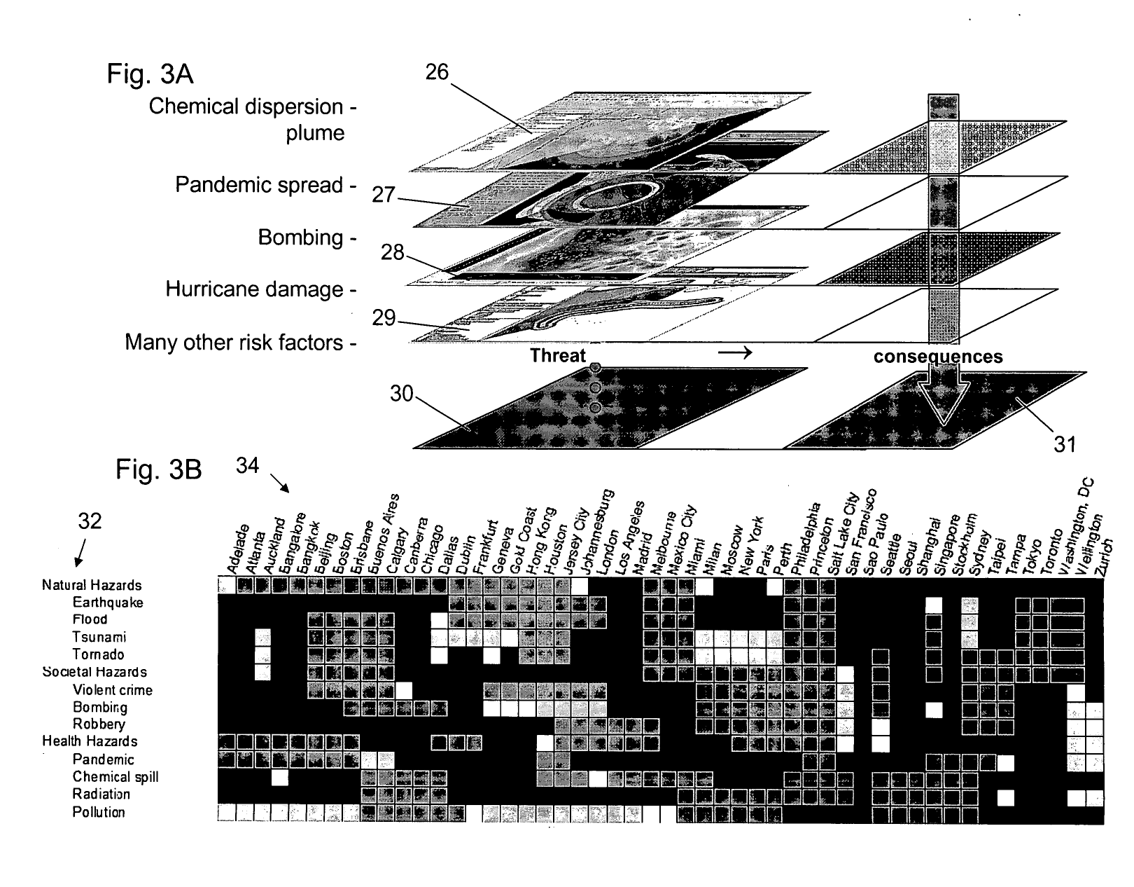

As shown in the example represented by FIG. 3A, if an end user seeks to compile knowledge for all major global metropolitan areas as represented by such risk factors as chemical dispersions 26, pandemic spreads 27, bombings 28 and hurricane damage 29, the user can request such via interface component, whereupon the model control bus (22 in FIG. 2) processes the request and selects the appropriate model(s) to implement in the analysis. The models are then run by model data bus/framework (16 in FIG. 1) against the data available to reach at least a compiled threat representation 30 and consequences representation 31. Opportunities and allocations can also be represented similar to 30 and 31. The threat representation and consequences representation are part of the response assessment to the request. A user of the present invention can vary the risk tolerance by appropriate computer interface to achieve a dynamically generated portrait of any of the threat, consequence, opportunity or allocation assessments. As shown in FIG. 3B, the threat and/or consequences representation can be visually represented via the interface component as a graphical display in the form of a matrix 33, with color coded squares (or optionally other shape) of generally the same sized area having various colors or shades representing the severity of the particular threat, risk, opportunity and/or consequence for the given location. Alternatively, they can also be represented in other visual and interactive forms including, but not limited to, gauges, sliders, meters, bar charts and similar representational embodiments. In the embodiment shown in FIG. 3B, the various hazards 32 are identified in the left column, and the various geographic areas modeled are identified textually along the top as at 34. Any combination of a location and a hazard, threat, risk and/or opportunity can result in a text report or other graphical display in order to communicate the risk/threat/opportunity. An automated and semi-automated change detection component can be provided as part of the model data bus of the present invention to determine whether changes in threat, opportunity or risk level in a particular location warrant notification to appropriate individuals. Such component can be provided as part of a regular response assessment, or can be specifically requested by the user via interface component. The response assessment can operate to show how a requested threat, risk or opportunity has changed over a certain time period. For example, the color-coded or shaded boxes in FIG. 3B can change colors or shades to reflect the analysis by the change detection component. Each state change can be associated with a specific date (e.g., Mar. 1, 2008), time period (e.g., March 2008) or date range (e.g., March-May 2008), with the date, time period or range also reflected on the interface display for the user. In one embodiment of the present invention, the interface component can be refreshed as a standard web browser either automatically or according to a user-established time interval to show the depiction as substantially continuous. The substantially continuous depiction can also be accomplished by video and other means.

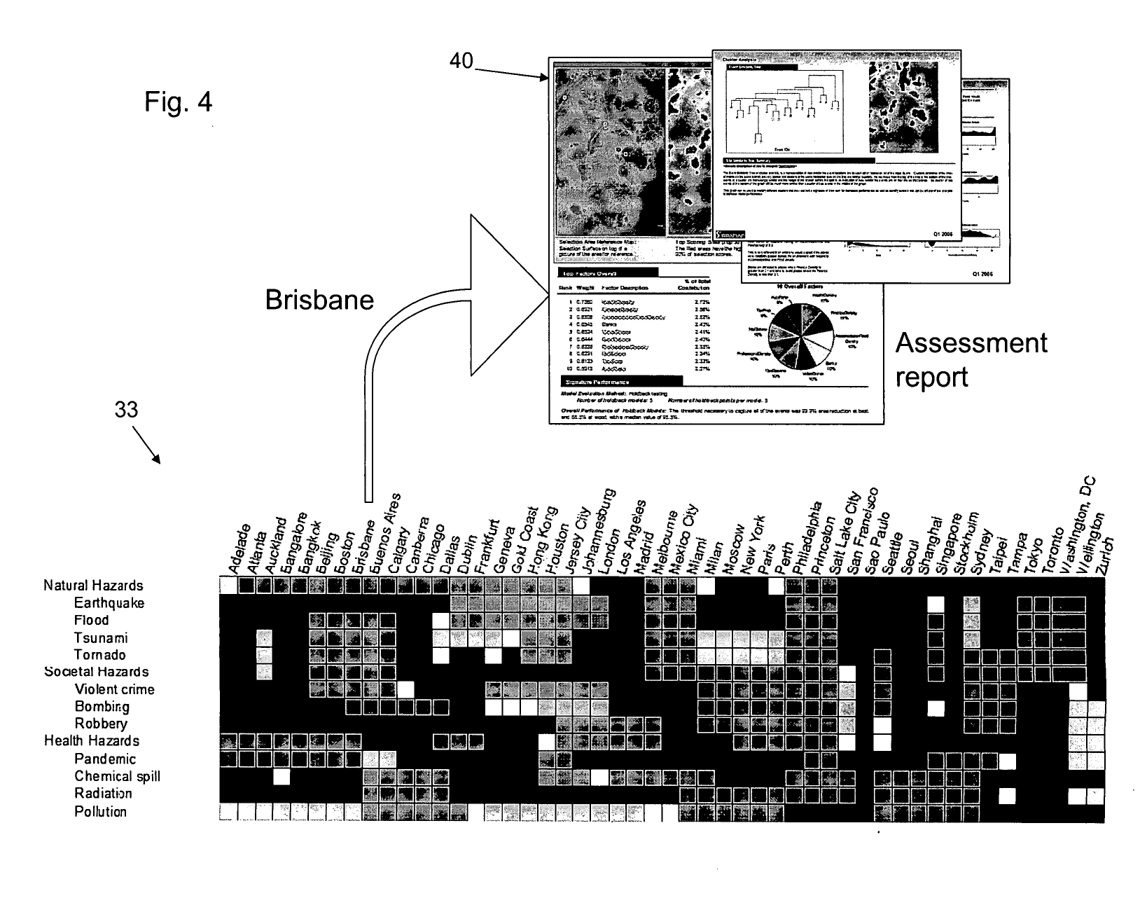

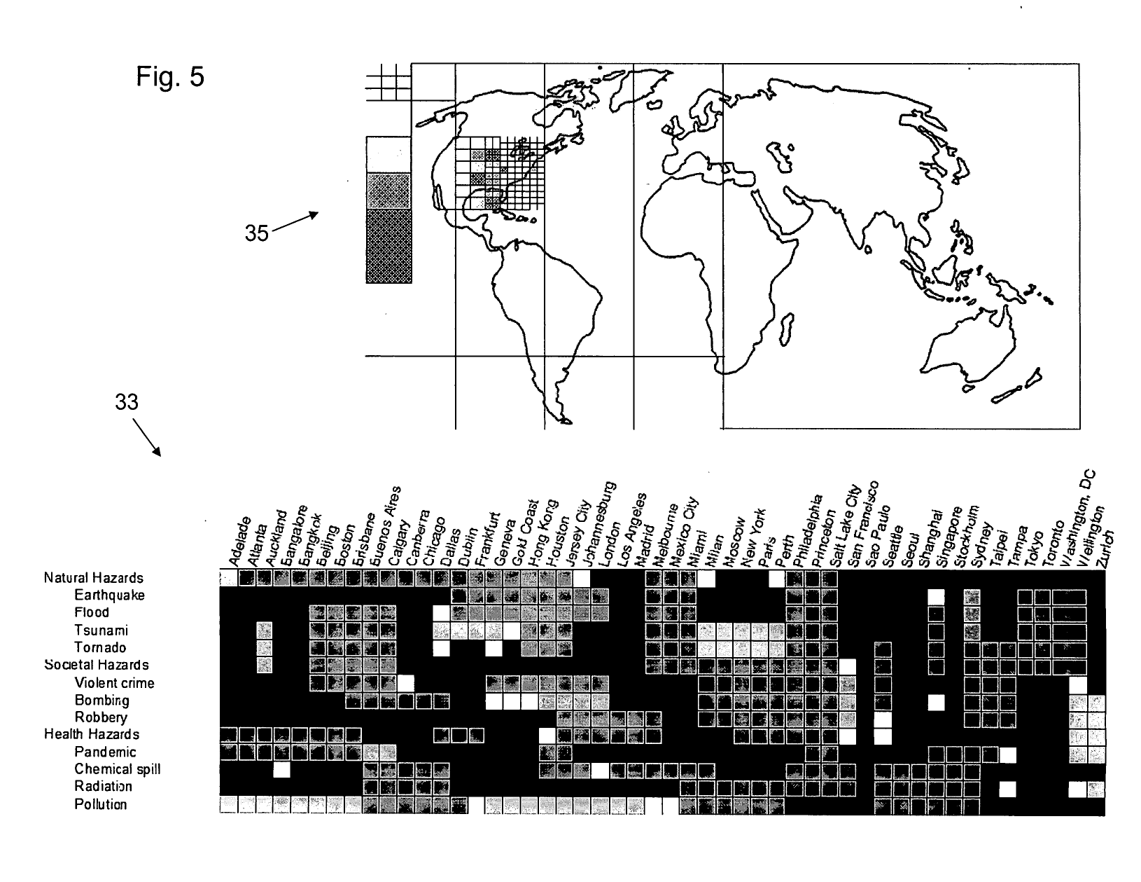

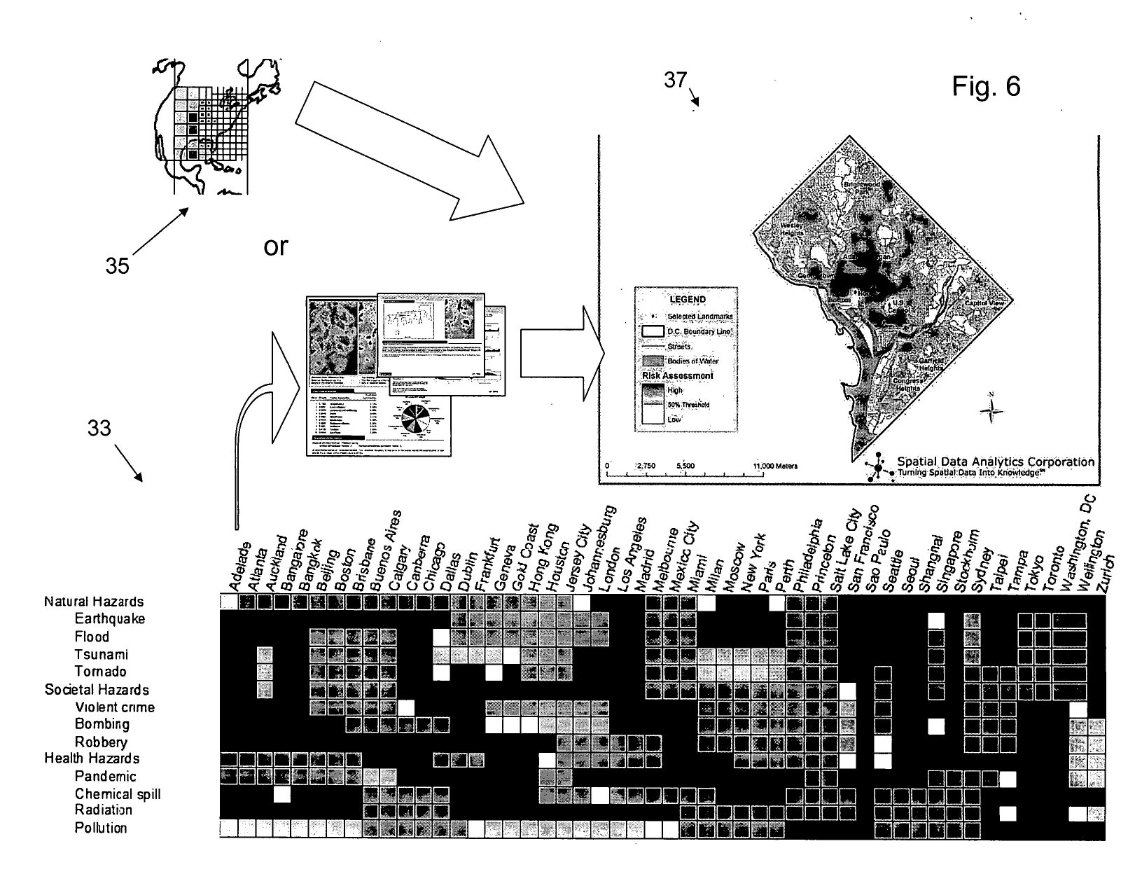

In one embodiment of the present invention, as shown in FIG. 4, each square in the matrix 33 can be exploited to provide further detail concerning the location and threat involved. For example, display 40 shows an assessment report for Brisbane, Australia in connection with natural hazards. As shown by the display 40, various tables, graphs, charts, images, photographs and textual information can be displayed. There is no limit to the type of information capable of being displayed, and images, videos, sounds and any other multi-media content are fully integratable with the present invention according to collection, storage, transmission and display techniques known in the art. As an alternative to the matrix view, the present invention can provide a globe view with particular areas of interest highlighted in grid fashion, as shown in FIG. 5. Regardless of presentation approach, the present invention allows the user to drill down spatially to discover additional relevant information pertaining to the user's query, such as shown by close-up view of hotspots on the map 37 in FIG. 6.

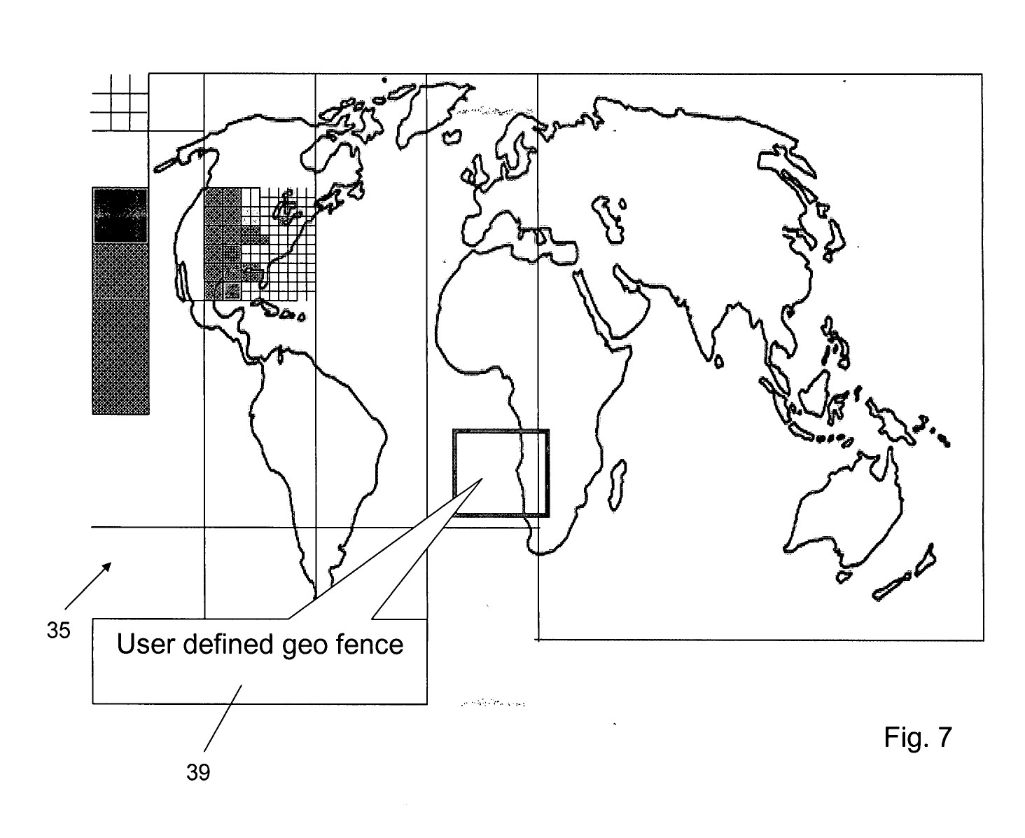

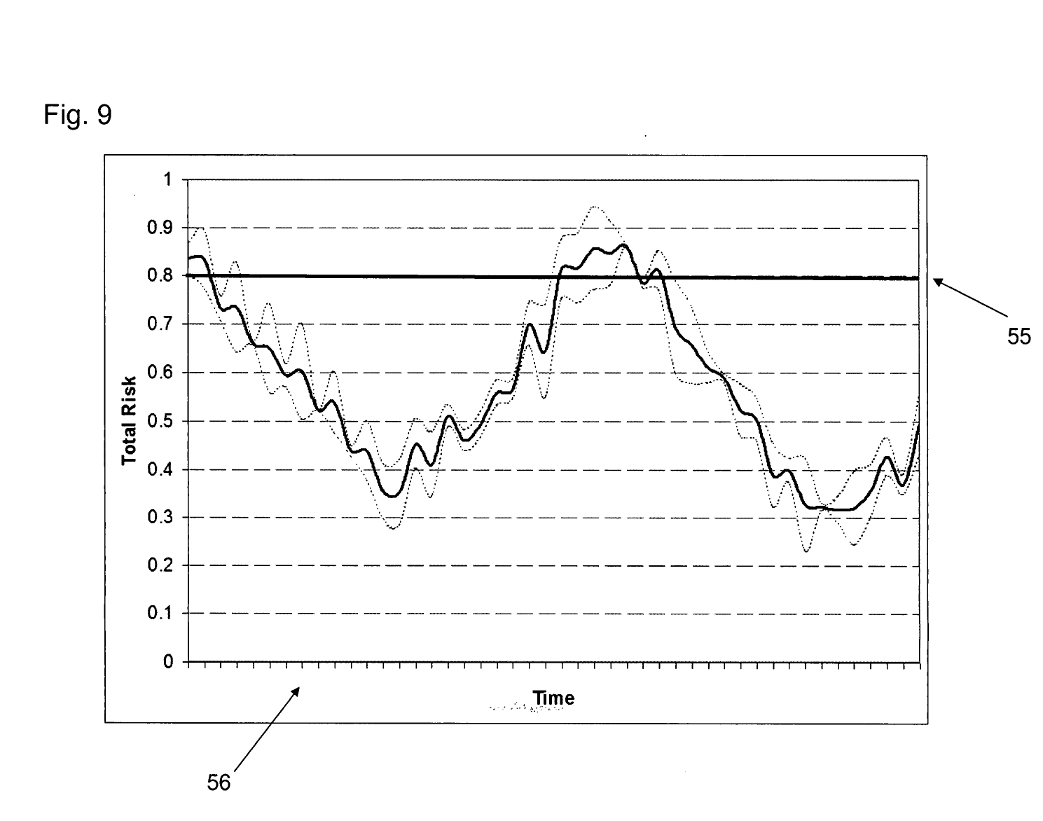

As shown in FIG. 7, a “geo-fence” can be defined or requested by a user, such that, if a risk/threat/opportunity level average in the fence, or a risk/threat/opportunity level “single” point (cell) in the fence is exceeded (or alternatively is diminished), an alert can be sent to the user (or an external system accessing the present invention with the proper user rights). The risk, threat or opportunity calculation can be monitored over time by a sentinel embodiment of the invention. Expected values of risk can be given a threshold 55 as shown in graph 56 in FIG. 9, above which the user is alerted. Alerting can be triggered by instantaneous movements across threshold limits, or can require some level of sustainment outside the thresholds over a customizable period of time. The present invention can include default alert triggers and can allow the user to set the default triggers according to preference. In one embodiment of the present invention, fuzzy logic can be used to trigger threshold alerting. Geo-fences can be previously established for user selection, or can be defined by the user through the interface component provided as part of interface/presentation layer 25. It will be appreciated that the interface component can be a part of a user communication device such as a laptop, cell phone, PDA, web-enabled communication device, CPU and other known devices.

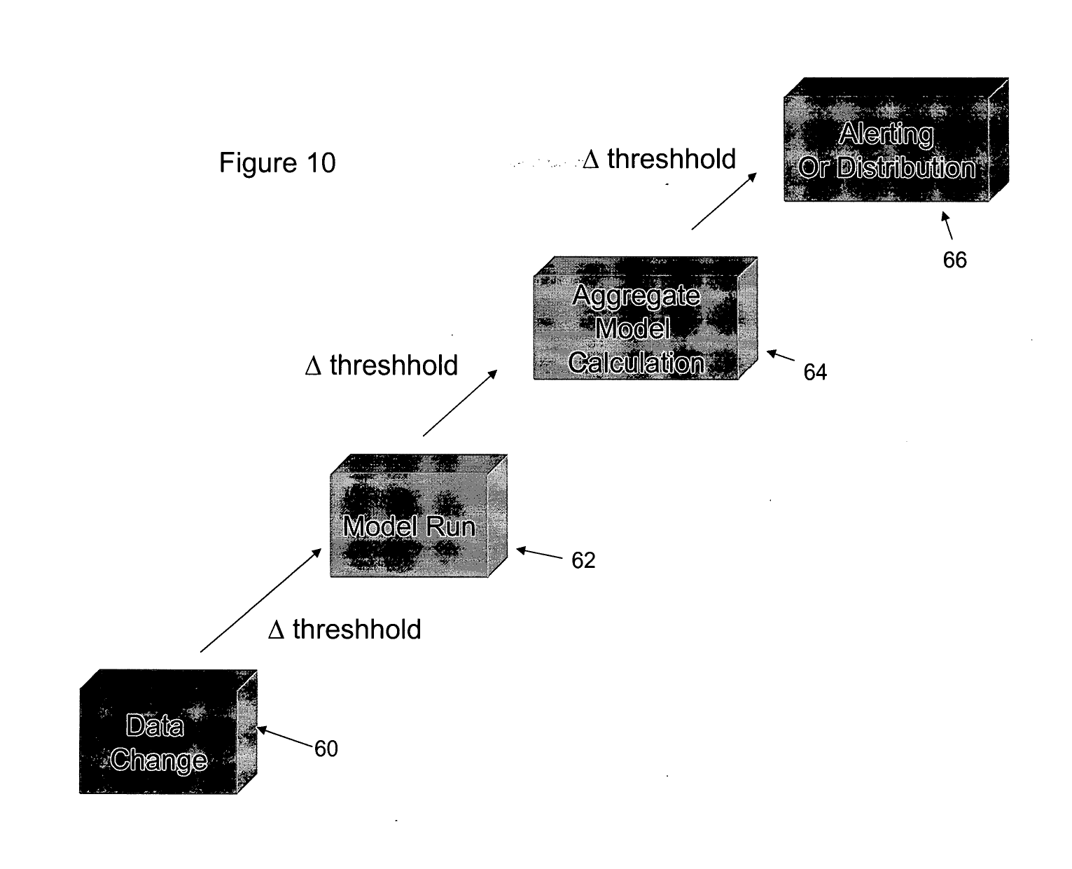

As shown in FIG. 10, changing underlying data as at step 60 can create a propagated effect through the system if specified thresholds are breached. For example, a hurricane model might not be updated unless the wind speed forecast data is updated by a user-defined or system-defined margin of sufficient magnitude to warrant the model being re-executed, as at step 62. In one embodiment, thresholds can include area or proximity triggers. In this situation, for example, a severe wind storm in the Pacific Ocean would probably not cause a Gulf of Mexico hurricane model to be updated because of the geographic separation. In other cases, a user might not have access to a certain dataset, so even if that dataset is changed it would not cause the user's threat and risk profiles to be updated (i.e. their view of the system). Similarly, models that are re-executed that result in a significant change in threat or risk could propagate this output into higher-level consolidation models in a threshold-dependent fashion as at step 64. Finally, if consolidated threat or risk changes of sufficient margin, a user (or external system) may be notified with alerts or reporting as at step 66, but again the margin required could be subject to user permissions, preferences, or some other similar means.

In various embodiments, the alert can be a short message, detailed text message, report style (PDF), or combination. The alert can be to cell phones, email addresses, or various other mediums tied to appropriate communication/display devices. In another embodiment of the invention, users with global positioning systems (GPS) can be alerted if their threat profile preferences are exceeded or diminished according to their up-to-date position. In one embodiment, a user might specify a relative radius of concern around their position such that the alerting and reporting is updated as a measure of the average, minimum, or maximum threat and risk within the circle (or some other geometry) defined by the radius.

User threat and risk preferences can be combined in various means to attribute an index score. Some users may only have access or subscription to certain models, data, or accuracy (resolution), resulting in user-specific aggregate views. In one embodiment, drill down capabilities to “dig into” the details of a model might be filtered or inaccessible due to user permissions.

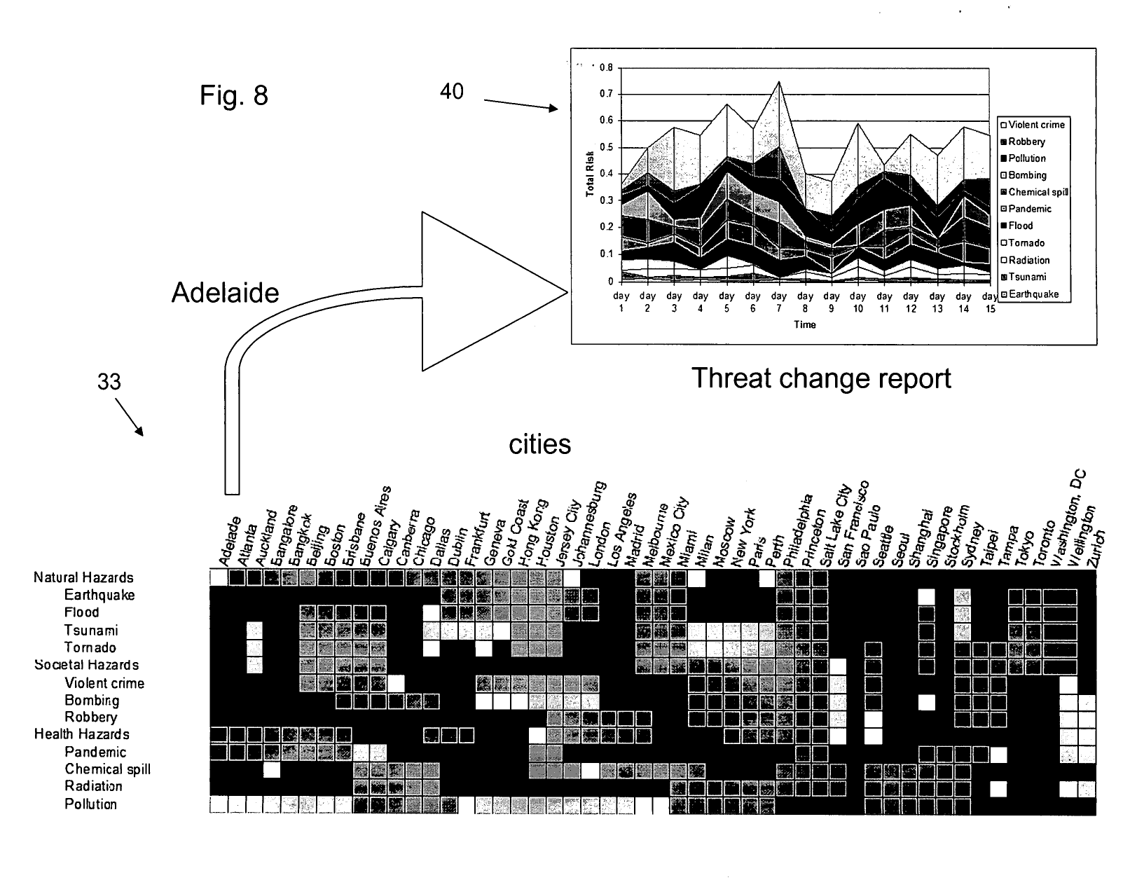

As shown in FIG. 8, an aggregate view of risk is available to the user to show the total risk present over time for a particular point, geo fence, or area. Time intervals can be scaled to represent minutes, days, weeks, months, years, centuries, or some other interval/measure of time.

The present invention can be employed with models facilitating economic decisions, business decisions, travel decisions, health and safety decisions, relocation decisions, political decisions, warfare decisions, transportation/shipment decisions and many other decisions which may be affected by geospatially model-able risks and threats.

External systems, such as other web-based sites, can communicate with the present invention to provide up-to-date historical or current information to aid in decision making. For example, a travel web-site can provide a threat and risk service for traveler destinations by operating in conjunction with the present invention. In another embodiment, rental cars equipped with GPS-driven navigation can offer a service to overlay threat and risk profiles to tourists on unfamiliar grounds.

It will further be appreciated that the user can input desired hypothetical scenarios into the system of the present invention in order to determine potential consequences associated therewith. In such an embodiment, the hypothetical scenario details can be presented through the interface component and a determination can be made as to which models are affected or involved in running the hypothetical scenario. The use can make the determination of model(s) involved or the model data bus can make the determination. The model data bus then executes the affected model or models against the proposed hypothetical data and the data 12/14 to reflect a threat, risk or opportunity assessment via the interface as described above. A consequence assessment as described above can be presented as part of the responsive assessment for one or more locations according to the request.

In the embodiment of the present invention as shown in FIG. 11, customer context information is provided as at 15 into analysis engine 19, along with customer asset and other specific factual data from customer data store 17, and this customer data is separate from the data 12A and 12B that is ultimately processed into global grid 14. Separating the customer data from the geospatial 12A and event 12B data permits the present invention to use the “clean” global grid data in multiple customer applications at the same time. In one embodiment of the present invention as shown in FIG. 11, configurable templates 27 are provided by global grid 14 to analysis engine 19 to facilitate entry and analysis of customer specific scenario data and customer objectives. Analysis engine can provide specific customer interfaces viewable through interface 25, for example, for this purpose. Geospatial information aggregator 21 and event data aggregator 23 are also shown in FIG. 11 for receiving, aggregating, formatting (if necessary) and presenting respective data to process engine 29, which processes the combined data and delivers it to global grid 14 for use as stated above, for example. The data 12A and 12B are filtered for trustworthiness and are updated in real-time once received by the respective aggregators 21, 23. Once an assessment has been made, it can be reported via presentation, reporting and alerting component 25. It will be appreciated that component 25 can be embodied as specific machines, systems or other customer resources and assets that are remotely programmable and/or controllable, whereby the customer can program the system of the present invention (e.g., through contextual disclosure 15 in FIG. 11) to initiate control instructions or recommendations for specific customer assets or resources. For example, if the customer indicates that it wants to immediately back up and shut down its computer systems in Bangladesh if it is determined that the summer temperatures remain above 95 degrees Fahrenheit for more than six hours at a time coinciding with a power outage, then the present invention, upon detecting such circumstances, can either send an alert to the customer with a recommendation to shut down its computer systems, or the present invention can direct such systems to shut down, as long as appropriate system control or access is provided to the present invention by the customer. The customer resources/assets subject to control can be fixed, mobile, human or infrastructure-related as described above. Additionally, the customer resources/assets can be defined, broken out, and ranked in terms of criticality or other variable for a particular situation of interest to the customer, such that the present invention delivers results, predictive modeling and/or real-time continuous monitoring as desired and appropriate based on the user's context.

The present invention can operate using a full end-to-end process including receiving geospatial data by the spatial data aggregator component 21; receiving event data by the event data aggregator component 23, where the geospatial data and event data can be provided on a global basis or for a particular area of interest (AOI); processing, by the data processor 29, the data received by the spatial data aggregator and the event data aggregator; receiving, by the global grid component 14, the data processed by the data processor 29; receiving, by the client interface 25, a situational assessment (e.g., 15) related to the area of interest (AOI) and information on one or more client assets, client resources, client objectives or client risk tolerances; and analyzing, through the provision of the analytical engine 19, the requested situational assessment. The analytical engine 19 includes the forecasting component 18 of FIG. 1 in one embodiment, whereby the analytical engine can assess the likelihood of future events of an event type pertaining to the situational assessment. The forecasting component can include the signature derivation component referenced above for deriving a geospatial signature pattern for past stored events of the assessed event type within the AOI. The analytical engine can further be provided with programming for issuing a response assessment, where the response assessment can be a communication alert or a signal control instruction to a client asset or client resource.

### Example 1

### Physical Threat: Terrorist Bombing

In this case, the invention can help identify locations within areas of interest where a terrorist bombing is likely to occur (threat likelihood), the likelihood of occurrence (vulnerability) and the impact of this threat (risk). The user can provide asset information through an interactive interface (e.g., 25) and based on organizational factors such as criticality of assets, resources and systems, the user's risk tolerance, and any other factors considered as part of the user's information obtained through data store 17 and customer context disclosure 15, the invention can then display areas of risk associated with terrorist bombings via component 25. Conversely, the invention can also display areas where the risk is within the tolerance limits where resources may be allocated. Once allocated, the real-time threat/risk monitoring capability of the present invention can then be engaged to get a real-time situational awareness of how the location and the assets within these locations are performing against the risk metrics. Alerts can be provided based on user preferences if threat/risk thresholds are exceeded. To facilitate the effectiveness of such alerts, emergency preparedness instructions and proactive planning capabilities can be established to allow organizations to respond optimally if an incident does occur. In such cases, evacuation routing and other incident response procedures can be delivered by the present invention through analysis engine 19 to a device or interface of choice of users. Further, the present invention can provide decision support in connection with the allocation of offensive and/or defensive resources.

### Example 2

### Insurance: Premium Leakage Protection

In this case, the invention can be engaged to understand the specific areas of interest within which an insurer may be considering underwriting one or more insurance policies. Based on the various layers of information such as sink holes, nearness of woods, natural hazard resilience, etc., insurance premiums can be calculated to a granular level so that the proper amount of premiums are collected based on trusted and real-time or near real-time information. Additionally, insurance companies can recommend safety options to protect structures or entities under consideration.

### Example 3

### Intermodal Freight Analysis

Supply chain is a critical process within many industries, especially transportation. Freight companies with a global disposition have to rely on intermodal (air, sea, road, rail) transportation mechanisms to get cargo from sender to receiver in many cases. In such cases, due to competitive pressures, it is important to run a highly efficient operation which may include outsourcing portions of the process to native entities. The invention can help analyze areas of opportunity and allocation. It can help determine the type of entities an organization can deal with by calculating risk. The present invention can further determine safer routes to travel, accidents occurring or reported, adjustment opportunities for carriers en route, enactable safety measures en route, and other preventive or countermeasure options available based on real-time information.

It will be apparent to one skilled in the art that any computer system that includes suitable programming means for operating in accordance with the disclosed methods also falls well within the scope of the present invention. Suitable programming means include any means for directing a computer system to execute the steps of the system and method of the invention, including for example, systems comprised of processing units and arithmetic-logic circuits coupled to computer memory, which systems have the capability of storing in computer memory, which computer memory includes electronic circuits configured to store data and program instructions, programmed steps of the method of the invention for execution by a processing unit. The invention also may be embodied in a computer program product, such as a diskette or other recording medium, for use with any suitable data processing system. The present invention can further run on a variety of platforms, including Microsoft Windows™, Linux™, Sun Solaris™, HP/UX™, IBM AIX™ and Java compliant platforms, for example.

The invention may be embodied in other specific forms without departing from the spirit or essential characteristics thereof. The present embodiments are therefore to be considered in all respects as illustrative and not restrictive, the scope of the invention being indicated by the claims of the application rather than by the foregoing description, and all changes which come within the meaning and range of equivalency of the claims are therefore intended to be embraced therein.

1. A computer-assisted analytical engine for facilitating location-based risk, threat or opportunity assessments, comprising:
an interface component for receiving instructions to provide a requested risk, threat or opportunity assessment pertaining to a requested location;
a model control bus in communication with the interface component for selecting one or more topical models associated with the requested assessment;
a framework for executing the one or more selected models against a database of geospatial information pertaining to the requested assessment in order to determine an associated risk, threat or opportunity response assessment for the requested location.

2. The engine of claim 1 wherein the interface component includes programming for presenting the response assessment as a graphical display in the form of a matrix of substantially equal-sized areas, each representing a threat type or a combination of threat types, and a location.

3. The engine of claim 1 wherein the interface component includes programming for presenting the response assessment as a combination of graphical displays representing a threat type, a combination of threats and a location.

4. The engine of claim 1 wherein the interface component includes programming for presenting the response assessment as a graphical display of a globe or globe portion, with a matrix of substantially equal-sized areas representing one or more areas therein.

5. The engine of claim 1 wherein the framework interfaces with a forecasting component for assessing the likelihood of future events of an event type pertaining to the requested assessment, with the forecasting component including a signature derivation component for deriving a geospatial signature pattern for past stored events of the assessed event type within the requested location.

6. The engine of claim 1 wherein at least two topical models are selected in connection with the requested assessment, and wherein the framework further determines an individual risk, threat or opportunity assessment based on each model individually as well as a combined risk, threat or opportunity assessment based on the at least two models combined, as part of the response assessment.

7. The engine of claim 1 wherein the interface component can receive instructions in the form of a requested location and at least one requested hazard type.

8. The engine of claim 1 wherein the interface component can receive instructions in the form of a request for a threat, risk, resource allocation or opportunity change assessment.

9. The engine of claim 8 wherein the framework produces a response assessment showing how a requested threat, risk, opportunity or combination thereof has changed over a time period.

10. The engine of claim 1 wherein the interface component can receive instructions in the form of a threat, risk or opportunity assessment for a plurality of locations, and wherein the engine produces a response assessment in the form of a single graphical user interface representing the response assessment for the requested plurality of locations, wherein a more detailed response assessment for a given location can be obtained via the response assessment graphical user interface.

11. A computer-assisted method for providing global consolidated risk and threat assessments, comprising the steps of:
receiving a communication from a user through a communication device of a particular geo-fence area for assessing risk;
combining, using a computer, two or more models for analyzing data associated with the geo-fence area and determining a quantifiable risk, threat or opportunity assessment associated with the geo-fence area; and
upon the quantifiable risk assessment meeting a threshold, notifying the user through the communication device.

12. A system for providing a real-time or near real-time, continuously updated, location-based risk, threat or opportunity assessment, comprising:
a computer-based model data bus accessing a database of geospatial information;
a computer-based health model component interacting with the model data bus to assess one or more health risks, threats or opportunities pertaining to one or more geographical locations;
a computer-based sociological model component interacting with the model data bus to assess one or more sociological risks, threats or opportunities pertaining to one or more geographical locations;
a computer-based natural hazard model component interacting with the model data bus to assess one or more natural hazard risks, threats or opportunities pertaining to one or more geographical locations;
a computer-based political model component interacting with the model data bus to assess one or more political risks, threats or opportunities pertaining to one or more geographical locations;
a computer-based economic model component interacting with the model data bus to assess one or economic more risks, threats or opportunities pertaining to one or more geographical locations; and
an interface in communication with the model data bus for reflecting a threat, risk or opportunity assessment for a location requested by a user of the interface.

13. The system of claim 12 wherein the database of geospatial information includes a database interface for receiving updated information, wherein the model data bus can repeatedly run one or one or more of the models using the updated information, and wherein the interface can be refreshed to depict a changing assessment based on the updated information.

14. The system of claim 13 wherein the interface is automatically refreshed at a given time interval such that the depicted assessment is substantially continuous.

15. The system of claim 13 wherein the database interface provides permission-based access to at least one data source, and wherein any updated information received is rated according to the at least one data source.

16. The system of claim 12 wherein the interface can receive proposed hypothetical geospatial data affecting one or more models, and wherein the model data bus can execute the affected model or model against the proposed hypothetical data and the database of geospatial information in order to reflect a threat, risk or opportunity consequence assessment via the interface.

17. The system of claim 12 wherein the model data bus executes, and the interface reflects, a consequence assessment for a plurality of locations requested by a user of the interface.

18. A method for providing real-time, computer-based representation of situational awareness in connection with a threat, risk, vulnerability or opportunity, comprising the steps of:
receiving, by a client interface, a situational assessment related to an area of interest (AOI) one or more client assets, client resources, client objectives or client risk tolerances;
receiving, by a spatial data aggregator component, geospatial data in connection with the AOI;
receiving, by an event data aggregator component, event data in connection with the AOI;
processing, by a data processor, the data received by the spatial data aggregator and the event data aggregator;
receiving, by a global grid component, the data processed by the data processor;
providing an analytical engine with a forecasting component for assessing the likelihood of future events of an event type pertaining to the situational assessment, with the forecasting component including a signature derivation component for deriving a geospatial signature pattern for past stored events of the assessed event type within the AOI; and
providing the analytical engine with programming for issuing a response assessment.

19. The method of claim 18 wherein the response assessment is a communication alert.

20. The method of claim 18 wherein the response assessment includes a signal control instruction to a client asset or client resource.
